(19) United States
(12) Patent Application Publication
(10) Pub. No.: US 2006/0143334 A1
(43) Pub. Date: Jun. 29, 2006

(54) Efficient buffer management

(76) Inventor: Uday R. Naik, Fremont, CA (US)

Correspondence Address: Ryder IP Law, PC;PortfolioIP, P.O. Box 52050, Minneapolis, MN, 55402, US

(21) Appl. No.: 11/024,882

(22) Filed: Dec. 29, 2004

(51) Int. Cl. G06F 3/06

(52) U.S. Cl. 710/56

(57) ABSTRACT

In general, in one aspect, the disclosure describes an apparatus that includes a receiver to receive data. A plurality of queues are used to store the data. The apparatus also includes at least one processor to process the data and a transmitter to transmit the data. The apparatus further includes a buffer manager to maintain availability of the buffers and to allocate free buffers. The buffer manager includes a bit vector stored in local memory for maintaining availability status of the plurality of buffers.

### BACKGROUND

Store-and-forward devices may receive data from multiple sources and route the data to multiple destinations. The data may be received and/or transmitted over multiple communication links and may be received/transmitted with different attributes (e.g., different speeds, different quality of service). The data may utilize any number of protocols and may be sent in variable length or fixed length packets, such as cells or frames. The store-and-forward devices may utilize network processors to perform high-speed examination/classification of data, routing table look-ups, queuing of data and traffic management.

Buffers are used to hold the data while the network processor is processing the data. The allocation of the buffers needs to be managed. This becomes more important as the amount of data being received, processed and/or transmitted increases in size and/or speed and the number of buffers increases. One common method for managing the allocation of buffers is the use of link lists. The link lists are often stored in memory, such as static random access memory (SRAM). Using link lists requires the processing device to perform an external memory access. External memory accesses use valuable bandwidth resources.

Efficient allocation and freeing of buffers is a key requirement for high-speed applications (e.g., networking applications). At very high speeds, the external memory accesses may become a significant bottleneck. For example, at OC-192 data rates, the queuing hardware needs to support 50 million enqueue/dequeue operations a second with two enqueue and dequeues per packet (one for the allocation and freeing and one for the queuing and scheduling of the packet at the network interface).

### DESCRIPTION OF FIGURES

FIG. 1 illustrates a block diagram of an exemplary system utilizing a store-and-forward device, according to one embodiment;

FIG. 2 illustrates a block diagram of an exemplary store and-and-forward device, according to one embodiment;

FIG. 3 illustrates a block diagram of an exemplary store-and-forward device, according to one embodiment;

FIG. 4 illustrates an exemplary network processor, according to one embodiment;

FIG. 5 illustrates an exemplary network processor, according to one embodiment;

FIG. 6 illustrates an exemplary hierarchical bit vector, according to one embodiment;

FIG. 7 illustrates an exemplary network processor, according to one embodiment; and

FIG. 8 illustrates an exemplary process flow for allocating buffers, according to one embodiment.

### DETAILED DESCRIPTION

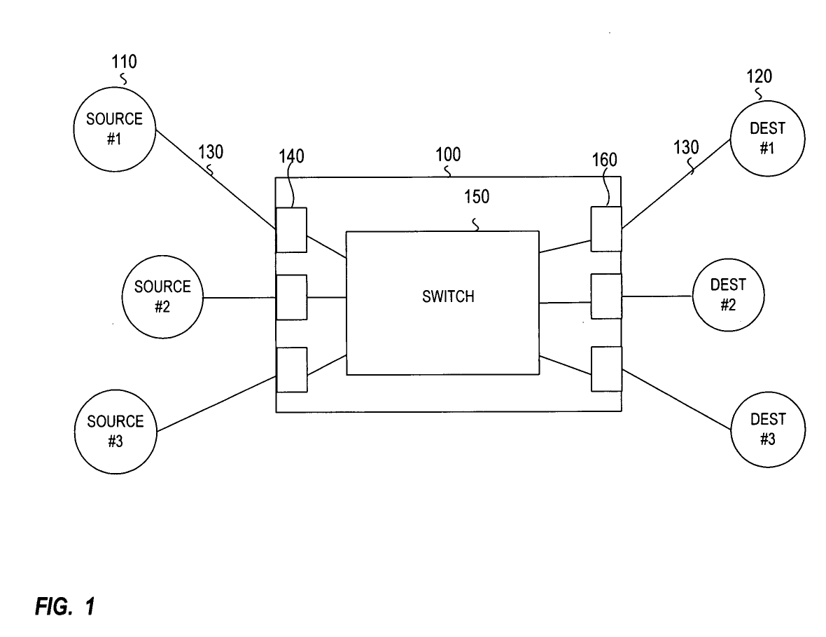

FIG. 1 illustrates an exemplary block diagram of a system utilizing a store-and-forward device 100 (e.g., router, switch). The store-and-forward device 100 may receive data from multiple sources 110 (e.g., computers, other store and forward devices) and route the data to multiple destinations 120 (e.g., computers, other store and forward devices). The data may be received and/or transmitted over multiple communication links 130 (e.g., twisted wire pair, fiber optic, wireless). The data may be received/transmitted with different attributes (e.g., different speeds, different quality of service). The data may utilize any number of protocols including, but not limited to, Asynchronous Transfer Mode (ATM), Internet Protocol (IP), and Time Division Multiplexing (TDM). The data may be sent in variable length or fixed length packets, such as cells or frames.

The store and forward device 100 includes a plurality of receivers (ingress modules) 140, a switch 150, and a plurality of transmitters 160 (egress modules). The plurality of receivers 140 and the plurality of transmitters 160 may be equipped to receive or transmit data having different attributes (e.g., speed, protocol). The switch 150 routes the data between receiver 140 and transmitter 160 based on destination of the data. The data received by the receivers 140 is stored in queues (not illustrated) within the receivers 140 until the data is ready to be routed to an appropriate transmitter 160. The queues may be any type of storage device and preferably are a hardware storage device such as semiconductor memory, on chip memory, off chip memory, field-programmable gate arrays (FPGAs), random access memory (RAM), or a set of registers. A single receiver 140, a single transmitter 160, multiple receivers 140, multiple transmitters 160, or a combination of receivers 140 and transmitters 160 may be contained on a single line card (not illustrated). The line cards may be Ethernet (e.g., Gigabit, 10 Base T), ATM, Fibre channel, Synchronous Optical Network (SONET), Synchronous Digital Hierarchy (SDH), various other types of cards, or some combination thereof.

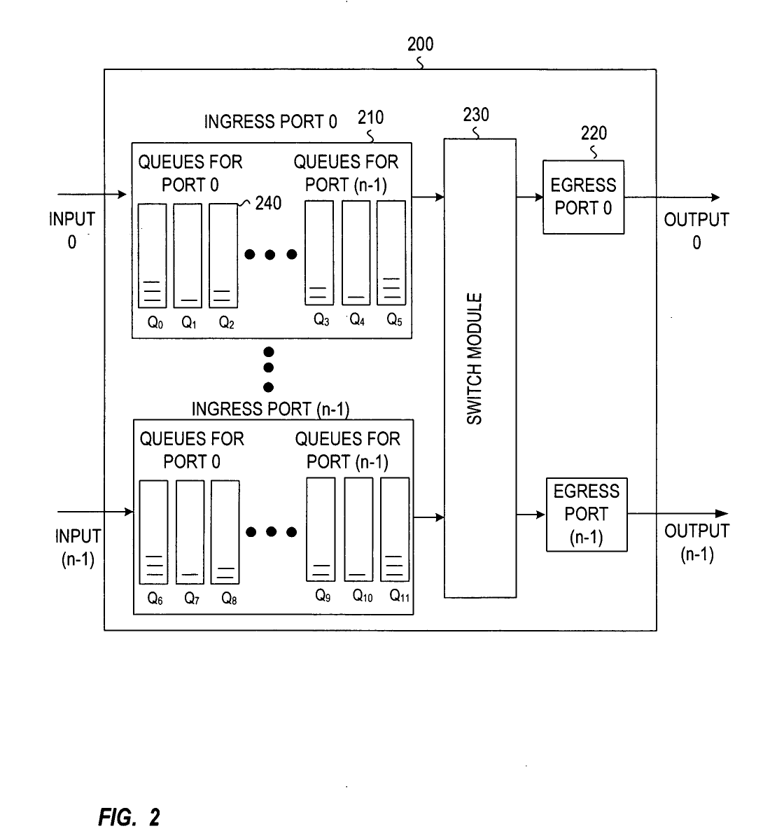

FIG. 2 illustrates a block diagram of an exemplary store and-and-forward device 200 (e.g., 100 of FIG. 1). The store-and-forward device 200 includes a plurality of ingress ports 210, a plurality of egress ports 220 and a switch module 230 controlling transmission of data from the ingress ports 210 to the egress ports 220. The ingress ports 210 may have one or more queues 240 for holding data prior to transmission. The queues 240 may be associated with the egress ports 220 and/or flows (e.g., size, period of time in queue, priority, quality of service, protocol). Based on the flow of the data, the data may be assigned a particular priority and the queues 240 may be organized by priority. As illustrated, each ingress port 210 has three queues 240 for each egress port 220 indicating that there are three distinct flows (or priorities) for each egress port 220. It should be noted that the queues 240 need not be organized by destination and priority and that each destination need not have the same priorities. Rather the queues 240 could be organized by priority, with each priority having different destinations associated therewith.

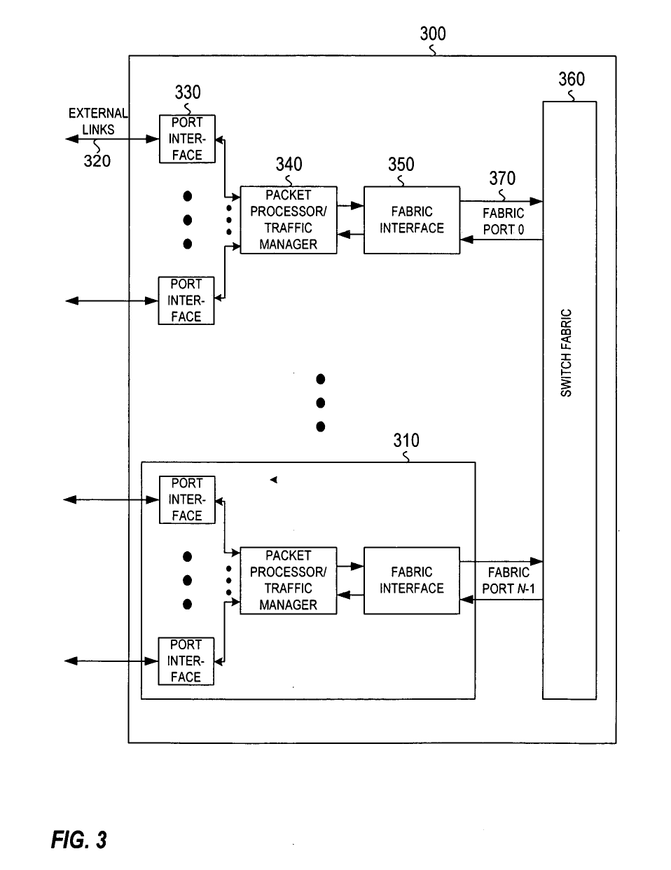

FIG. 3 illustrates a block diagram of an exemplary store-and-forward device 300 (e.g., 100, 200). The device 300 includes a plurality of line cards 310 that connect to, and receive data from external links 320 via port interfaces 330 (a framer, a Medium Access Control device, etc.). A packet processor and traffic manager device 340 (e.g., network processor) receives data from the port interface 330 and provides forwarding, classification, and queuing based on flow (e.g., class of service) associated with the data. A fabric interface 350 connects the line cards 310 to a switch fabric 360 that provides re-configurable data paths between the line cards 310. Each line card 310 is connected to the switch fabric 360 via associated fabric ports 370 (from/to the switch fabric 360). The switch fabric 360 can range from a simple bus-based fabric to a fabric based on crossbar (or crosspoint) switching devices. The choice of fabric depends on the design parameters and requirements of the store-and-forward device (e.g., port rate, maximum number of ports, performance requirements, reliability/availability requirements, packaging constraints). Crossbar-based fabrics are the preferred choice for high-performance routers and switches because of their ability to provide high switching throughputs.

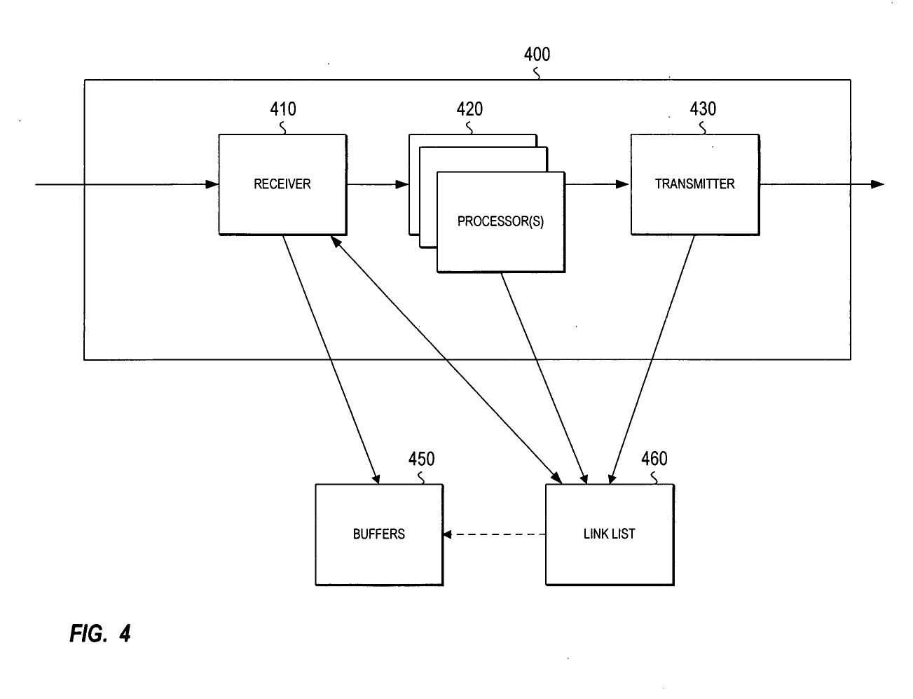

FIG. 4 illustrates an exemplary network processor 400 (e.g., 340 of FIG. 3). The network processor 400 includes a receiver 410 to receive data (e.g., packets), a plurality of processors 420 to process the data, and a transmitter 430 to transmit the data. The plurality of processors 420 may perform the same tasks or different tasks depending on the configuration of the network processor 400. For example, the processors 420 may be assigned to do a specialized (specific) task on the data received, may be assigned to do various tasks on portions of the data received, or some combination thereof.

While the data is being processed (handled) by the network processor 400 the data is stored in buffers 450. The buffers 450 may be off processor memory, such as a SRAM. The network processor 400 needs to know which buffers 450 are available to store data (assign buffers). The network processor 400 may utilize a link list 460 to identify which buffers 450 are available. The link list 460 may identify each available buffer by the identification (e.g., number) associated with the buffer. The link list 460 would need to be allocated enough memory to hold the identity of each buffer. For example, if there was 1024 buffers a 32-bit word would be required to identify an appropriate buffer and the link list would require 1024 32-bit words (32,768 bits) so that it could include all of the buffers possible. The link list 460 may be stored and maintained in off processor memory, such as a SRAM.

When data is received by the receiver 410, the network processor 400 requests an available buffer from the link list 460 (external memory access). Once the receiver receives an available buffer 450 from the link list, the receiver 410 writes the data to the available buffer 450. Likewise, when the transmitter 430 removes data from the buffer, the network processor 400 informs the link list 460 that the buffer 450 is available (external memory access). During processing of the data, the processors 420 may determine that the buffer 450 can be freed (e.g., corrupt data, duplicate data, lost data) and informs the link list 460 that the buffer 450 is available (external memory access). The external memory accesses required to monitor (allocate and free) the buffers 450 takes up valuable bandwidth. At high speeds the external memory accesses to the link list 460 for allocation and freeing of buffers may become a battle neck in the network processor 400.

The link list 460 may maintain the status of the buffers 450 based on the buffers 450 it allocates to the receivers 410 and the buffers 450 freed by the transmitter 430. The buffers 450 allocated may be marked as used (allocated) as soon as the link list 460 provides the buffer 450 to the receiver 410. The link list 460 may mark the buffer 450 allocated as long as the receiver 410 does not indicate that it did not utilize the buffer 450 for some reason (e.g., lost data). The link list 460 may indicate that the buffer 450 is utilized as long as it receives an acknowledgement back from the receiver 410 within a certain period of time. That is, if the receiver 410 doesn't inform the link list 460 within a certain time the buffer 450 will be marked available again. The link list 460 may indicate that the buffer 450 is utilized as long as it determines that the buffer 450 in fact has data stored therein within a certain period of time (e.g., buffer 450 informs link list 460, link list 460 checks buffer 450 status). The buffers 450 freed may be marked as freed as soon as the link list 460 receives the update from the transmitter 430 and/or the processors 420. The link list 460 may indicate that the buffer 450 is free as long as it determines that the buffer 450 in fact has been freed within a certain period of time (e.g., buffer 450 informs link list 460, link list 460 checks buffer 450 status).

The storage, processing and transmission (handling) of data within a buffer is known as a handle (or buffer handle). Accordingly, when used herein the terms “handle” or “buffer handle” may be referring to the allocation, processing, or freeing of data from a buffer. For example, the allocation of a buffer 450 (to receive and process data) may be referred to as receiving a buffer handle (at the receiver 410). Likewise, the freeing of a buffer 450 (removal of data therefrom) may be referred to as transmitting a buffer handle (from the transmitter 430).

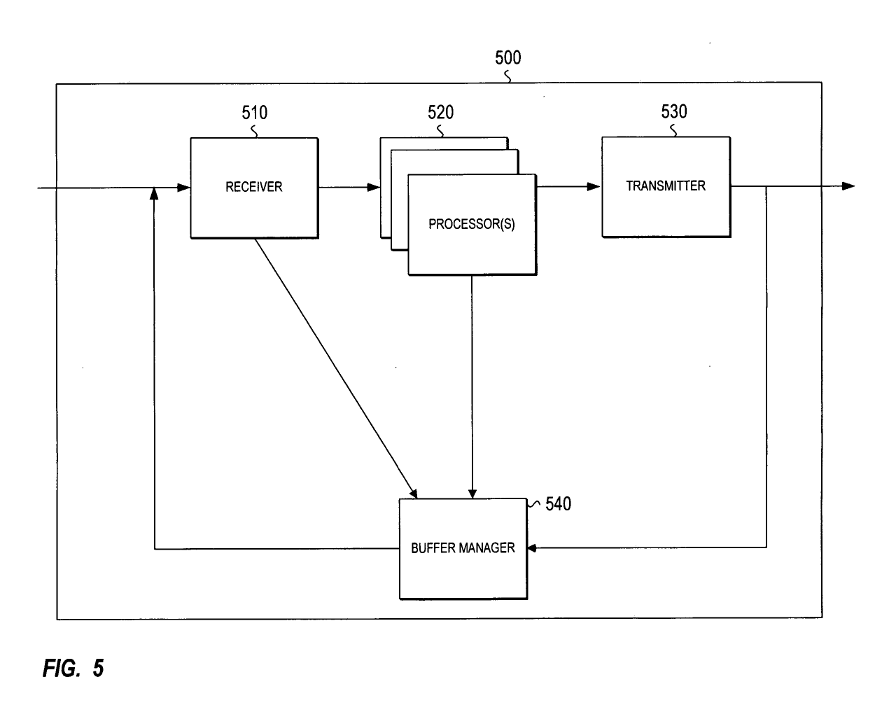

FIG. 5 illustrates an exemplary network processor 500 (e.g., 340 of FIG. 3) that does not use the queuing support in hardware (e.g., link list 460). The network processor 500 takes advantage of the fact that buffers may be allocated and freed in any order. Like the network processor 400 of FIG. 4, the network processor 500 includes a receiver 510, a plurality of processors 520, and a plurality of buffers (not illustrated). The network processor 500 also includes a buffer manager 540 to track which buffers contain data (free, allocated) and to allocate free buffers (e.g., transmit and receive buffer handles).

The buffer manager 540 may be a microengine that tracks the status (free, allocated) of the buffers. The buffer manager 540 may utilize a bit vector to track the status of the buffers. The bit vector may include a bit associated with each buffer. For example, if a buffer is free (has no data stored therein) an associated bit in the bit vector may be active (e.g., set to 1) and if the buffer is occupied (has data stored therein) the associated bit may be inactive (e.g., set to 0). As the bit vector utilizes only a single bit for each buffer it is significantly smaller than a link list (e.g., link list 460 of FIG. 4). For example, if 1024 buffers were available the link list would require approximately 32 times the storage as the bit vector.

As the size of the bit vector is much smaller then the link list, it may be stored in local memory. Local memory is memory that is accessible very efficiently with low latency by a mircoengine. There is usually a very small amount of local memory available. Tracking the status in local memory enables the network processor 500 to avoid external memory accesses (to the link list in SRAM) and accordingly conserve bandwidth. That is, the network processor 500 does not require any additional SRAM bandwidth for allocation and freeing of packet buffers. This takes considerable load off the queuing hardware.

The buffer manager 540 may allocate buffers to the receiver 510 once the receiver 510 requests a buffer. The buffer manager 540 may provide a buffer for allocation based on a status of the buffers maintained thereby. The buffer manager 540 may maintain the status of the buffers (free, allocated) by communicating with the receiver 510, the processors 520 and the transmitter 530. The buffer manager 540 may track the status of the buffers in a similar manner to that described above with respect to the link list. For example, the buffer manager 540 may mark a buffer as allocated as soon as it provides the buffer to the receiver 510, may mark it allocated as long as it does not hear from the receiver 510 to the contrary, or may mark it allocated as long as it receives an acknowledgment from the receiver 510 within a certain time. The buffer manager 540 may mark buffers freed once it receives buffers that need to be freed (e.g., corrupt data, duplicate data) from the processors 520, or buffers that had data removed (are freed) from the transmitter 530.

The buffer manager 540 may determine which buffer was next to allocate the next buffer by performing a find first bit set (FFS) on the bit vector. The FFS is an instruction added to many processors to speed up bit manipulation functions. The FFS instruction looks at a word (e.g., 32 bits) at a time to determine the first bit set (e.g., active, set to 1) within the word if there is a bit set within the word. If a particular word does not have a bit set the FFS instruction proceeds to the next word.

As the number of buffers increases, the bit vector increases in size as does the amount of time it takes to perform a FFS on the bit vector. For example, if there are 1024 buffers and the system is a 32 bit word system it could take the buffer manager 540 32 cycles (1024 bits divided by 32 bits/word) to find the first free buffer if it is represented by one of the last bits in the bit vector.

Accordingly, a hierarchical bit vector may be used. With a hierarchical bit vector the lowest level has a bit associated with each buffer. A next higher level has a single bit that summarizes a plurality of bits below. For example, if the system is a 32-bit word system a single bit at the next higher level may summarize 32 bits on the lower level. The bit on the next higher level would be active (set to 1) if there are any active bits on the lower level. The bits on the lower level are ORed and the result is placed in the corresponding bit on the next higher level. The overall number of buffers available and the word size of the system dictate at least in part the structure of a hierarchical bit vector (number of levels, number of bits that are summarized by a single bit at a next higher level).

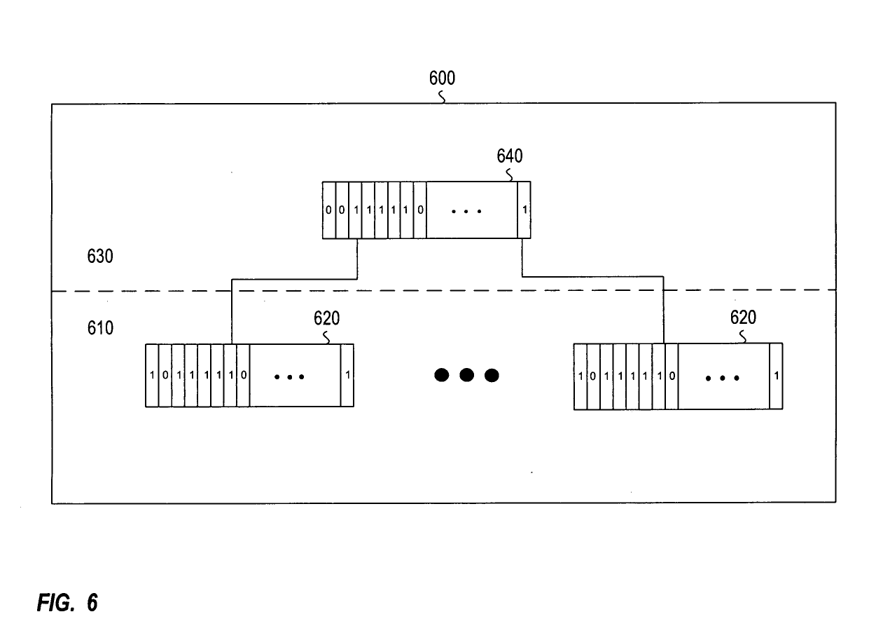

FIG. 6 illustrates an exemplary hierarchical bit vector 600. The hierarchical bit vector 600 may be stored in local memory of a data allocater mircoengine (e.g., data allocater 540). The hierarchical bit-vector 600 is two levels. A lowest level 610 has a bit for each buffer with the bits being segmented into words 620. Each of the words 620 may be summarized as a single bit on a next level 630 of the hierarchical bit vector 600. The bits at the next level 630 are segmented into words (e.g., a single word) 640. If, for example, the system was a 32-bit word system each of the words in the hierarchical bit vector 600 may also be 32 bits. Accordingly, the top-level word 640 would be a single 32-bit word with each bit representing a 32-bit word 620. The lower level 610 would have a total of 32 32-bit words 620. The exemplary hierarchical bit vector 600 therefore can track the occupancy status of 1024 buffers using 33 words of local memory (32 words 620 and 1 summary word 640).

Using the exemplary hierarchical bit vector 600 allows the buffer manager microengine to find a next available buffer from the 1024 buffers, no matter what bit in the bit vector represents the buffer by using only two FFS instructions. The first FFS instruction finds a first active bit in the top-level word 640. The active bit indicates that there is an active bit (free buffer) in an associated lower level word 620. The second FFS is performed on the word 620 that was identified in the first FFS and finds a first active bit in the lower level word 620 indicating that the associated buffer is free for allocation. By way of example, performing a first FFS on the hierarchical bit vector 600 determines that the first active bit in the top level word 640 is the 3rd bit that indicates that the 3rd word 620 on the lower level 610 has at least one active bit (free buffer). Performing a second FFS on the third word 620 of the lower level 610 determines that the first bit is active. Accordingly, the buffer associated with the 1^{st} bit of the 3rd word (bit 64) is the first buffer that would be selected for allocation.

As previously noted, the hierarchical structure of a bit vector can be selected based on a number of parameters that one of ordinary skill in the art would recognize. One of the parameters is the word size (n) of the system. The words used in the bit vector should be integer multiples of the word size (e.g., 1n, 2n). While it is possible to use a fraction of the word size, as one skilled in the art would clearly recognize that would not be a valuable use of resources. The word size on one level of the hierarchy need not be the same as one other levels of the hierarchy. For example, an upper level may consist of a 32-bit word with each bit summarizing availability of buffers associated with an associated lower level 64-bit word. The lower level having a total of 32 64-bit words or 64 32-bit words with each two 32-bit words forming a 64-bit word. This embodiment would require one FFS operation (assuming 32-bit word system) on the upper level to determine which lower level word had an available buffer and 1 or 2 FFS operations to determine which bit within the lower level 64 bit word had a free corresponding buffer. This hierarchical bit vector could be stored in 65 words of memory (64 32-bit words for the lower level and one for the upper level) and track the availability of 2048 buffers (64 words*32 bits/word).

Conversely, an upper level may have a 64-bit word with each bit summarizing bit summarizing availability of buffers associated with an associated lower level 32-bit word. The lower level having a total of 64 32-bit words. This embodiment would take one or two FFS operations (assuming 32-bit word system) on the upper level to determine which lower level word had an available buffer and one FFS operation to determine which bit within the lower level 32-bit word had a free corresponding buffer. This hierarchical bit vector could be stored in 66 words of memory (64 32-bit words for the lower level and two for the upper level) and also track the availability of 2048 buffers.

Another factor is the number of buffers in the system. For example, if the system had over 30,000 buffers you may want to use a 3 level hierarchy in order to have a system that could find the first available buffer in a few cycles. For example, a 3 level hierarchy with each level having 32-bit words could track availability of 32,728 buffers (33*32*32) and find the buffer within 3 cycles (one FFS on each level). This hierarchical bit vector could be stored in 1057 words of memory (32*32 words on the first level, 32 words on the second level, and 1 word on the upper level)

Referring back to FIG. 5, the buffer manager 540 directly sends buffer handles (next available buffers) to the receiver 510. This embodiment would likely require that the buffer manager 540 determine the next buffer handle (available buffer) when the receiver 510 requested one. This would require that the buffer manager 540 to perform multiple FFS instructions (e.g., two utilizing the hierarchical bit vector 600). Having to wait for a determination of the next buffer handle is not efficient. Likewise, the receiver 510, the processors 520, and the transmitter 530 are directly providing requests and updates to the buffer manager 540. If the buffer manager 540 is not ready to receive an update (e.g., is performing a FFS operation) it may not be able to receive the updates. The updates may be lost or may be backlogged thus effecting the operation of the network processor 500 and the system it is utilized in (e.g., store and forward device).

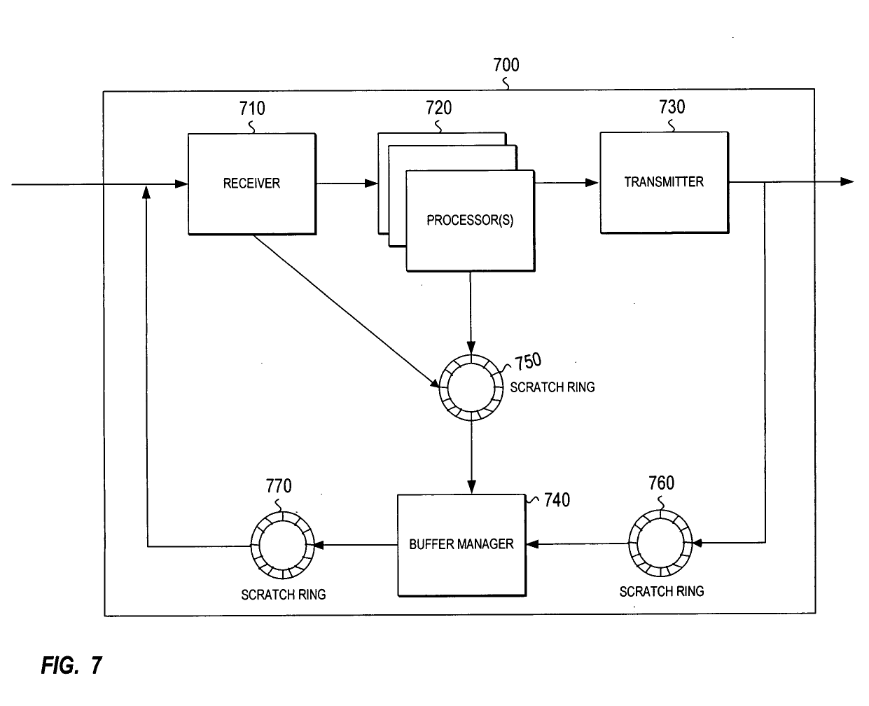

FIG. 7 illustrates an exemplary network processor 700. Like the network processor 500 of FIG. 5, the network processor 700 includes a receiver 710 to receive data and store the data in available buffers, a plurality of processors 720 to process the data, a transmitter 730 to transmit the data, a plurality of buffers (not illustrated) to store the data, and a buffer manager 740 for allocating and freeing the buffers (tracking the status of the buffers). The network processor 700 also includes storage devices for temporarily holding inputs to and outputs from the buffer manager 740. A storage device 750 may receive from the receiver 710 and/or the processors 720 buffers that need to freed (e.g., corrupt data, duplicate data, lost data). A storage device 760 may receive from the transmitter 730 buffers that have been freed. A storage device 770 may receive from the buffer manager 740 next available buffers for allocation. The storage devices 750, 760, 770 may be scratch rings, first in first out buffers or other types of buffers that would be known to one of ordinary skill in the art. The storage devices 750, 760, 770 may be large in size and may have relatively high latency. The use of the storage devices enables the network processor 700 to account for the delays associated with waiting for the buffer manager 540 of FIG. 5 to perform FFS operation or update the status of the buffers (the bit vector or the hierarchical bit vector).

The storage device 770 may receive from the buffer manager 740 a plurality of next available buffer identities. That is, the buffer manager 740 can determine next available buffers without regard to the receiver 710 (e.g., when it is available to do so) and provide a next available buffer identity to the storage device 770 each time an FFS instruction is performed and determines the next available buffer. The number of next available buffers that the storage device 770 can hold is based on the size and structure of the storage device 770. For example, if the storage device 770 is a scratch ring containing a certain number (e.g. 92) of words then the storage device 770 can hold up to that many available buffers. The storage device 770 enables the buffer manager 740 to determine next available buffers prior to the receiver 710 requesting (or needing) them. When the receiver 710 needs a buffer it selects one from the storage device 770, it does not need to wait for the buffer manager 740 to determine a next available buffer. Once the receiver 710 selects a next available buffer, the buffer identity is removed from the storage device 770 and the buffer manager 740 may place another one in the storage device 770 at that point. The use of the storage device 770 enables the receiver 710 to be assigned up to the number of buffers stored in the storage device 770 without needing the buffer manager 740 to determine a next available buffer.

The storage device 760 may receive from the transmitter 730 a plurality of freed buffers. That is, as soon as the transmitter 730 frees a buffer it can provide the freed buffer identity to the storage device 760. The transmitter 730 can continue to provide freed buffer identities to the storage device 760 (as long as the storage device has the bandwidth) without regard for when the buffer manager 740 updates the bit vector (hierarchical bit vector). The buffer manager 740 can receive a freed buffer identity from the storage device 760 and update the bit vector without regard for the transmitter (e.g., when it is available to do so). Once the buffer manager 740 processes a freed buffer identity, the buffer is removed from the storage device 760 and the transmitter 730 may place another one in the storage device 760 at that point. The use of the storage device 770 enables the transmitter 730 to free up to the number of buffers stored in the storage device 760 without needing the buffer manager 740 to update the buffer status (bit vector).

The storage device 750 may receive from the receiver 710 and/or the processors 720 the identity of buffers that can be freed. That is, as soon as the receiver 710 and/or the processors 720 determine that a buffer can be freed the buffer identity is provided to the storage device 750. The receiver 710 and the processors 720 can continue to perform their functions without regard to when the buffer manager 740 updates the bit vector (hierarchical bit vector). The buffer manager 740 can receive buffer identities from the storage device 750 and update the bit vector without regard for the receiver 710 and/or the processors 720 (e.g., when it is available to do so). Once the buffer manager 740 processes a buffer identity, the buffer is removed from the storage device 750 and the receiver 710 and/or the processors 720 may place another one in the storage device 750 at that point. As illustrated, the storage device 750 received updates regarding buffers (e.g., buffers to be freed) from both the receiver 710 and the processors 720. In an alternative embodiment, a separate storage device may be used for updates from the receiver 710 and the processors 720.

According to one embodiment, the storage devices 760, 770 may be next neighbor (NN) rings as the receiver 710 and the transmitter 730 communicate directly with one another and are simply providing the identities of buffers that have been allocated or freed. The NN rings may be low latency small size rings, whereas scratch rings may be larger size rings with higher latency.

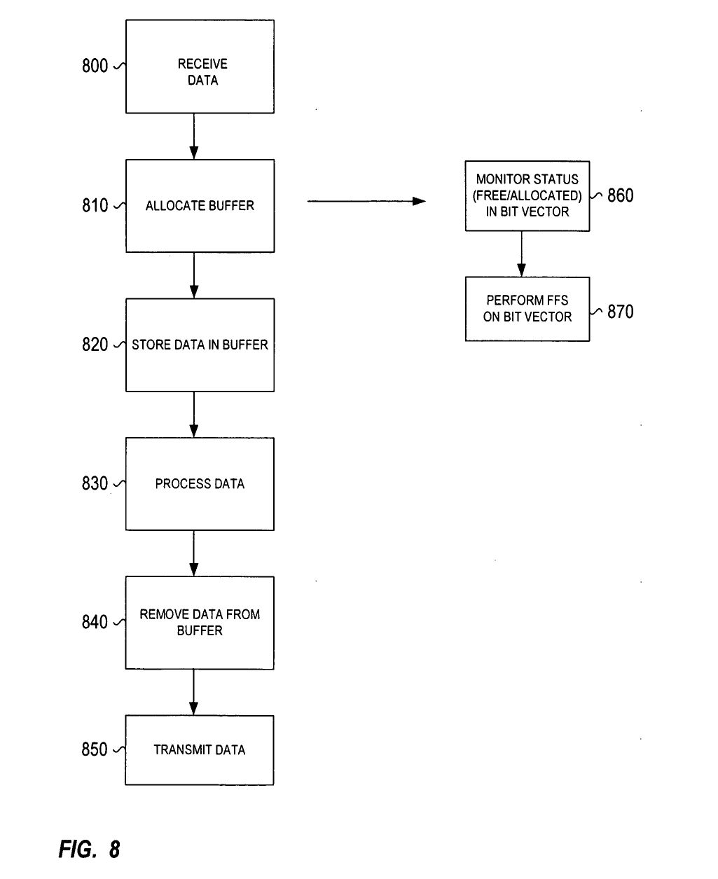

FIG. 8 illustrates an exemplary process flow for allocating buffers. A network processor receives data (e.g., packets) 800. A buffer is allocated for the data 810 and the data is stored in the buffer 820 while the data is being processed 830. Once the data is processed it is removed from the buffer 840 and transmitted to its destination 850. It should be noted that the data could be transmitted prior to being removed from the buffer. The allocation of the buffers 810 includes monitoring the status (free/allocated) of the buffers in a bit vector (e.g., hierarchical but vector) 860. FFS instructions are performed on the bit vector to determine the next available buffer 870.

Network processors (e.g., 400, 500, 700) have been described above with respect to store-and-forward devices (e.g., routers, switches). The various embodiments described above are in no way intended to be limited thereby. Rather, the network processors could be used in other devices, including but not limited to, network test equipment, edge devices (e.g., DSL access multiplexers (DSLAMs), gateways, firewalls, security equipment), and network attached storage equipment.

Although the various embodiments have been illustrated by reference to specific embodiments, it will be apparent that various changes and modifications may be made. Reference to “one embodiment” or “an embodiment” means that a particular feature, structure or characteristic described in connection with the embodiment is included in at least one embodiment. Thus, the appearances of the phrase “in one embodiment” or “in an embodiment” appearing in various places throughout the specification are not necessarily all referring to the same embodiment.

Different implementations may feature different combinations of hardware, firmware, and/or software. It may be possible to implement, for example, some or all components of various embodiments in software and/or firmware as well as hardware, as known in the art. Embodiments may be implemented in numerous types of hardware, software and firmware known in the art, for example, integrated circuits, including ASICs and other types known in the art, printed circuit broads, components, etc.

The various embodiments are intended to be protected broadly within the spirit and scope of the appended claims.

What is claimed:

1. An apparatus comprising
a receiver to receive data;
at least one processor to process the data;
a transmitter to transmit the data;
a plurality of buffers to store the data while the data is being handled by the apparatus; and
a buffer manager to manage availability of the buffers and to allocate free buffers, wherein said buffer manager includes a bit vector stored in local memory for maintaining availability status of said plurality of buffers.

2. The apparatus of claim 1, wherein the bit vector is a hierarchical bit vector.

3. The apparatus of claim 2, wherein said buffer manager determines a next available buffer by performing one or more find first bit set (FFS) operations on the bit vector.

4. The apparatus of claim 1, wherein said buffer manager allocates free buffers to said receiver.

5. The apparatus of claim 4, further comprising a storage device to store one or more next available buffers determined by said buffer manager until said receiver requires them.

6. The apparatus of claim 1, wherein said transmitter informs said buffer manager when it has freed a buffer.

7. The apparatus of claim 6, further comprising a storage device to store one or more buffers freed by said transmitter until said buffer manager is ready to receive freed buffer identity and update availability status.

8. The apparatus of claim 1, wherein said at least one processor informs said buffer manager when a buffer needs to be freed.

9. The apparatus of claim 1, further comprising a storage device to store buffers that need to be freed according to said at least one processor until said buffer manager is ready to receive freed buffer identity and update availability status.

10. A method comprising:
receiving data for processing;
allocating a next available buffer for storage of the data, wherein the next available buffer is allocated based on availability of a plurality of buffers that is tracked in a locally stored bit vector; and
storing the data in the allocated next available buffer.

11. The method of claim 10, wherein the bit vector is a hierarchical bit vector.

12. The method of claim 10, wherein said allocating includes performing one or more find first bit set (FFS) operations on the bit vector.

13. The method of claim 10, wherein said allocating includes allocating the next available buffer to a receiver after the receiver receives the data so that receiver can store the data in the next available buffer.

14. The method of claim 10, wherein said allocating includes allocating one or more next available buffers to a storage device, wherein the allocation of the next available buffers to the storage device may be done in advance of a receiver receiving data and requiring a next available buffer, and wherein the storage device provides a next available buffer to the receiver after the receiver receives the data so that receiver can store the data in the next available buffer.

15. The method of claim 10, further comprising
processing the data;
transmitting the data from the buffer, wherein the buffer is free and available for allocation after the data is transmitted; and
updating the bit vector to reflect the buffer is free.

16. The method of claim 15, wherein said updating includes providing a buffer manager the identity of the buffer that was freed, wherein the buffer manager updates the bit vector.

17. The method of claim 15, wherein said updating includes providing one or more frees buffer identities to a storage device, wherein the freed buffer identities can be provided to the storage device in advance of a buffer manager being ready to update the bit vector, and wherein the buffer manager retrieves the free buffer identities from the storage device and updates the bit vector.

18. A method comprising,
tracking occupancy status of a plurality of buffers in a bit vector stored in local memory of a buffer manager; and
performing an operation on the bit vector to determine a next available buffer.

19. The method of claim 18, wherein the bit vector is a hierarchical bit vector.

20. The method of claim 18, further comprising providing the next available buffer to a receiver when the receiver receives data and needs a buffer to store the data in.

21. The method of claim 18, further comprising
providing one or more next available buffers to a storage device as the next available buffers are determined; and
providing a next available buffer from the storage device to a receiver when the receiver receives data and needs a buffer to store the data in.

22. The method of claim 18, further comprising receiving the identity of freed buffers and updating the bit vector accordingly.

23. An apparatus comprising
a receiver to receive data and store data in buffers for processing;
at least one processor mircoengine to process the data;
a transmitter to remove the data from the buffers and transmit the data; and
a buffer manager microengine to maintain availability status of the buffers and to allocate next free buffers to said receiver, wherein said buffer manager includes a hierarchical bit vector stored in local memory for maintaining availability status of the buffers.

24. The apparatus of claim 23, further comprising a memory ring to receive one or more allocated next free buffers from said buffer manager microengine and to provide the allocated next free buffers to said receiver when needed by said receiver.

25. The apparatus of claim 23, further comprising a memory ring to receive one or more free buffers from said transmitter and to provide the free buffers to said buffer manager mircoengine when requested by said buffer manager mircoengine.

26. The apparatus of claim 23, wherein said buffer manager mircoengine determines a next available buffer by performing one or more find first bit set (FFS) operations on the hierarchical bit vector.

27. A store and forward device comprising
a plurality of interface cards, wherein the interface cards include network processors, and wherein the network processors include
a receiver to receive data;
at least one processor to process the data;
a transmitter to transmit the data; and
a buffer manager to maintain availability of a plurality of buffers and to allocate free buffers, wherein said buffer manager includes a bit vector stored in local memory for maintaining availability status of the plurality of buffers; and
a crosspoint switch fabric to provide selective connectivity between said interface cards.

28. The store and forward device of claim 27, wherein the bit vector is a hierarchical bit vector.

29. The store and forward device of claim 27, wherein the buffer manager determines a next available buffer by performing one or more find first bit set (FFS) operations on the bit vector.

30. The store and forward device of claim 27, wherein the network processor further includes
a memory ring to receive one or more allocated free buffers from the buffer manager and to provide the allocated free buffers to the receiver when needed by the receiver; and
a memory ring to receive one or more free buffers from the transmitter and to provide the free buffers to the buffer manager when requested by the buffer manager mircoengine.
